(19) United States
(12) Patent Application Publication
(10) Pub. No.: US 2007/0093924 A1
(43) Pub. Date: Apr. 26, 2007

(54) Telediagnosis viewer

(75) Inventors: Michael Engel, Leonberg (DE); Ralf Keefer, Weinstadt (DE); Heinrich Kolster, Esslingen (DE); Michael Mueller, Stuttgart (DE); Ulrich Teufel, Nuertingen (DE)

Correspondence Address: CROWELL & MORING LLP;INTELLECTUAL PROPERTY GROUP, P.O. BOX 14300, WASHINGTON, DC, 20044-4300, US

(73) Assignee: Daimlerchrysler AG, Stuttgart (DE)

(21) Appl. No.: 10/558,096

(22) PCT Filed: Apr. 16, 2004
(86) PCT No.: PCT/EP04/04042

§ 371 Date: Dec. 4, 2006

(30) Foreign Application Priority Data
May 23, 2003 (DE) 103 23 390.3

(51) Int. Cl. G06F 19/00

(52) U.S. Cl. 700/104

(57) ABSTRACT

The invention relates to a human-machine interface for a telediagnosis system. The data conversion, the data completion, the data preparation and the computation of a diagnosis result ensue in a central diagnosis center provided in the form of a call center. The computed diagnosis result is displayed in completed form on a display screen whereby enabling a selected assistant in the call center to view the result. The communications expense for the telediagnosis can be considerably reduced, in particular, by the data completion being performed first in the central diagnosis center. As a result, the exchange of complete text files is unnecessary. This enables, in particular, the use of the SMS standard from the mobile radio telephone industry. An error message is conveyed from the technical system to be diagnosed, particularly from the vehicle to be diagnosed, by means of an SMS message. This SMS message is evaluated by a diagnostic program, and a first diagnosis result is computed. This first diagnosis result is automatically converted into an XML structure by the human-machine interface, and is supplemented with additional data concerning the vehicle or from the vehicle according to further evaluation of the first diagnosis result. The data completion automatically ensues once triggered by the original SMS. This diagnosis result supplemented in such a manner and the prepared diagnosis result are displayed on a display screen whereby enabling the assistant in the call center to view the result. This relieves the burden placed upon the assistant of many routine requests for additional information.

This invention relates to a telediagnosis viewer as a man-machine interface for a diagnostic system. This diagnostic system is used to analyze a technical system by means of a diagnostic program and a knowledge base. The man-machine interface is helpful in diagnosing motor vehicles in particular.

The technological background for the inventive man-machine interface is formed by an XML document management system for diagnostic data in development, production and service. A brief summary of such a management system is included in the press release from Software AG on Oct. 10, 2002 “Workflow-Supported XML Document Management for Diagnostic Data in Development, Production and Service.” This press release describes a server application for management of XML documents, particular emphasis being placed on diagnosis of electronic control units in motor vehicles. In modern automobiles, this testing and diagnosing of electronic control units and their mutual interactions are increasingly important. This is equally true of automotive development, from the first prototype to a vehicle ready for mass production, to production and subsequent customer service as well. This task requires the use of diagnostic tools that are specialized in the areas of development, production and service and must be supplied with relevant information about the control units. The corresponding data must be managed centrally by the responsible engineers, must be reproducible in all versions and must be converted in a frozen state to binary code for the control units and the test equipment in the event of a model release. The document management system described here operates on the basis of the XML standard. In addition to a central XML document for the diagnosis, the document management system offers the possibility of managing a plurality of different document types and linking them together in a version-secure manner in a document container defined for each control unit; such document types include, for example, specifications, test results and supplementary text information. In addition, the document management system manages all the metadata required for rule-based workflow control. A user himself can compile the procedures and documents relevant to him in a personal area via an intranet portal and thereby define rapid access for certain control units. Use of viewers for diagnosing complex technical equipment is known from European Patent Application EP 0 784 275 A1, for example. The viewer here is permanently installed on the device to be diagnosed, namely a Xerox copier. A knowledge base stored in a data memory of the Xerox copier can be viewed using this viewer. This knowledge base is comprised of markup language elements. The individual markup language elements of the knowledge base are organized hierarchically in the form of multiple decision trees. Essentially the knowledge base represents the repair handbook for the Xerox copier. The knowledge base contains a list of possible errors occurring in the Xerox copier. This list can be inspected via the viewer and the respective information can be found in the knowledge base by input of a suspected error by a service technician into the viewer. For each error description in the knowledge base, the respective repair instructions can also be localized via a reference mark and displayed on the viewer for the service technician. In addition to merely locating text passages, a diagnostic program in the form of a diagnostic consultant is also accessible via the viewer. The viewer here serves as a man-machine interface for operation of the diagnostic program and for output of the calculated diagnostic results. The diagnostic program in the Xerox machine offers the service technician specific observations in the form of a selection menu; the technician can confirm or deny these observations. From the selected menu points, the diagnostic program uses an analytical algorithm to select the most probable error diagnosis; in the decision tree of the knowledge base, the diagnostic program jumps to the top branching point of the error diagnosis thus determined. If there are multiple causes for the presumed error, then a service technician having the viewer can search through to the actual cause of the error by way of the uppermost node of the decision room [sic; decision tree] and ultimately receive the respective repair instructions by way of yes/no decision questions displayed on the viewer.

The viewer and the diagnostic system described above are not suitable for the purposes of telediagnosis. The viewer in the system described above always operates on the basis of a completely stored data record. There is no transmission of error data. The diagnostic system and the viewer are always designed and used only in an instrument-specific manner. Refinement of the diagnostic results supplied initially by the diagnostic consultant is possible only through direct visual certification by the service technician. Such a man-machine interface in the form of a viewer cannot be used for telediagnosis applications to further improve upon a preliminary diagnostic result. In telediagnosis, visual contact with the object to be diagnosed is not usually possible.

Therefore, the object according to the present invention is to provide a man-machine interface in the form of a telediagnosis viewer with which complex technical systems, in particular motor vehicles, can be diagnosed by a service technician from a call center.

This object is achieved with a man-machine interface for a diagnostic system having the features of Claim 1. Other advantageous embodiments of this invention are contained in the subclaims and in the description.

Mainly the following advantages are achieved with the inventive man-machine interface:

Data conversion, data completion and data processing as well as calculation of a diagnostic result are performed in a central diagnostic center, which is designed as a call center. The calculated diagnostic result is visualized on a display screen in a completed form for a selected employee at the call center. In particular, the communication complexity for the telediagnosis can be greatly reduced due to the fact that data completion is performed only in the central diagnostic center. Therefore, it is not necessary to exchange entire text data files. This permits in particular the use of the SMS standard from the mobile wireless telephone industry. By means of an SMS message, an error message is transmitted from the technical system to be diagnosed, in particular from the vehicle to be diagnosed. This SMS message is analyzed by a diagnostic program and a first diagnostic result is calculated. This first diagnostic result is automatically converted by the man-machine interface into an XML structure and supplemented by additional data about the vehicle or from the vehicle, depending on a renewed analysis of the first diagnostic results. The data completion is also performed here automatically at first, also triggered by the original SMS. Only the diagnostic result supplemented and processed in this way is displayed on a display screen for the employee at the call center. Therefore the employee is relieved of making numerous routine inquiries to obtain additional information.

Another advantage of the inventive man-machine interface is that the interface can be configured by employees at the call center. For example, an employee at the call center can select the language in which the diagnostic result is displayed. This makes it possible for him to evaluate the diagnostic result in his native language, for example.

Another advantage of the man-machine interface is automated variant handling. Depending on the vehicle identification number, which was already transmitted with the first SMS, the data completion unit is able to recognize model-specific particulars of the vehicle to be diagnosed and to request data that takes into account these model-specific particulars and must always be requested and to do so by means of a subsequent data request so that the employee at the call center already receives a first diagnostic result that incorporates the model-specific particulars. Inquiries by the employee concerning which model, which model variant, which control units are installed, etc. can thus be processed automatically by the man-machine interface and this information need no longer be obtained by making inquiries over the telephone by the employee at the call center.

The object of the present invention is achieved by a man-machine interface for a telediagnosis system which supplies from the incoming SMS messages a first diagnostic result in the form of an initial data packet on the basis of a knowledge base and a diagnostic program. This initial data packet is automatically converted to an XML structure and stored as an XML data file. By means of a data completion unit that analyzes the data of the XML data file, the first diagnostic result is improved either automatically or after sending a manual request by requesting additional data from the technical system to be diagnosed and taking this data into account in the diagnosis. The diagnostic result is displayed on a display screen and the employee at the call center can influence the sequence of the diagnostic process in a targeted manner by means of an inactive user surface.

In an advantageous embodiment of the man-machine interface, thesauruses in various languages are also included, and the employee at the call center can have the diagnostic result displayed on the display screen in the language of his choice by selecting a thesaurus.

In another advantageous embodiment of the inventive man-machine interface, a completion unit configuration is also incorporated. This completion unit configuration contains a logic unit configured for the model of the respective technical system to be diagnosed. The required model-specific additional data can be read out of the technical system by means of this logic unit and ultimately displayed for the employee at the call center.

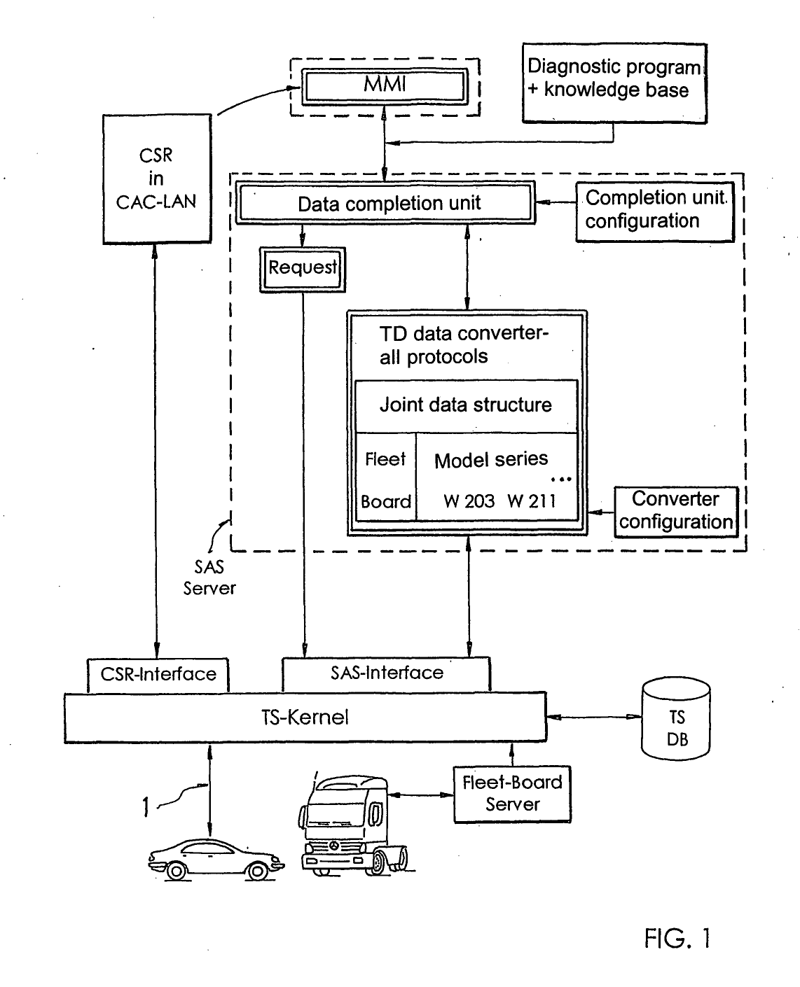

The present invention is explained in greater detail below with reference to FIG. 1 through FIG. 8, in which:

FIG. 1 shows a layer model for the telediagnosis system with the respective modules;

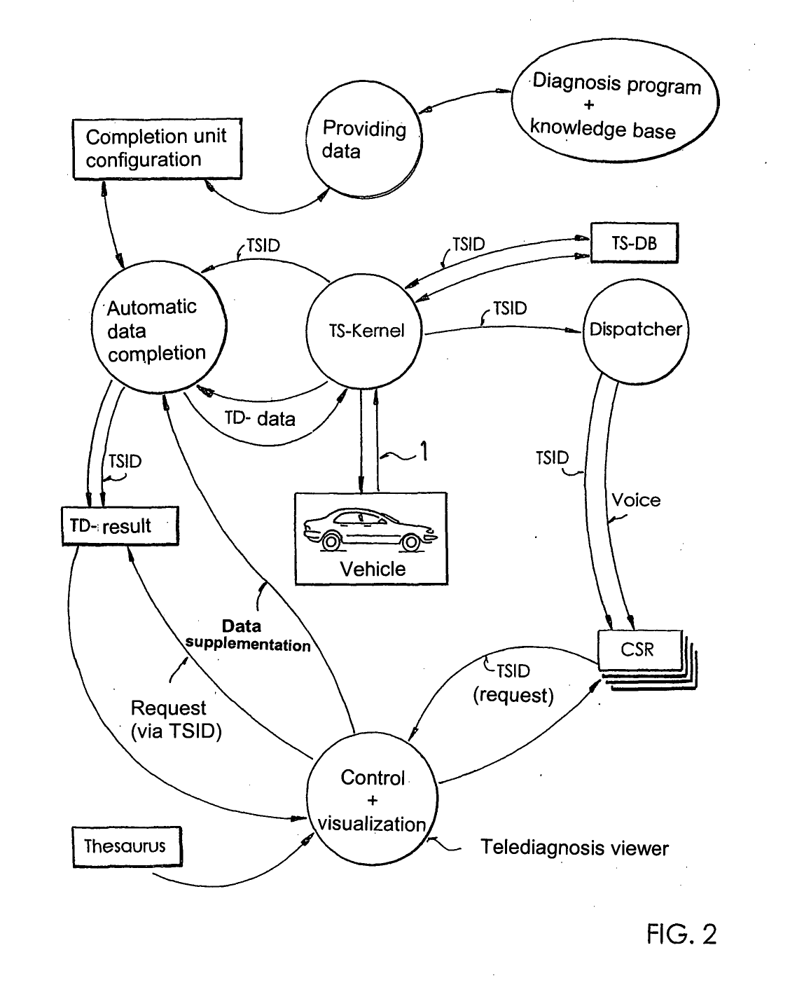

FIG. 2 shows a process overview for the telediagnosis system;

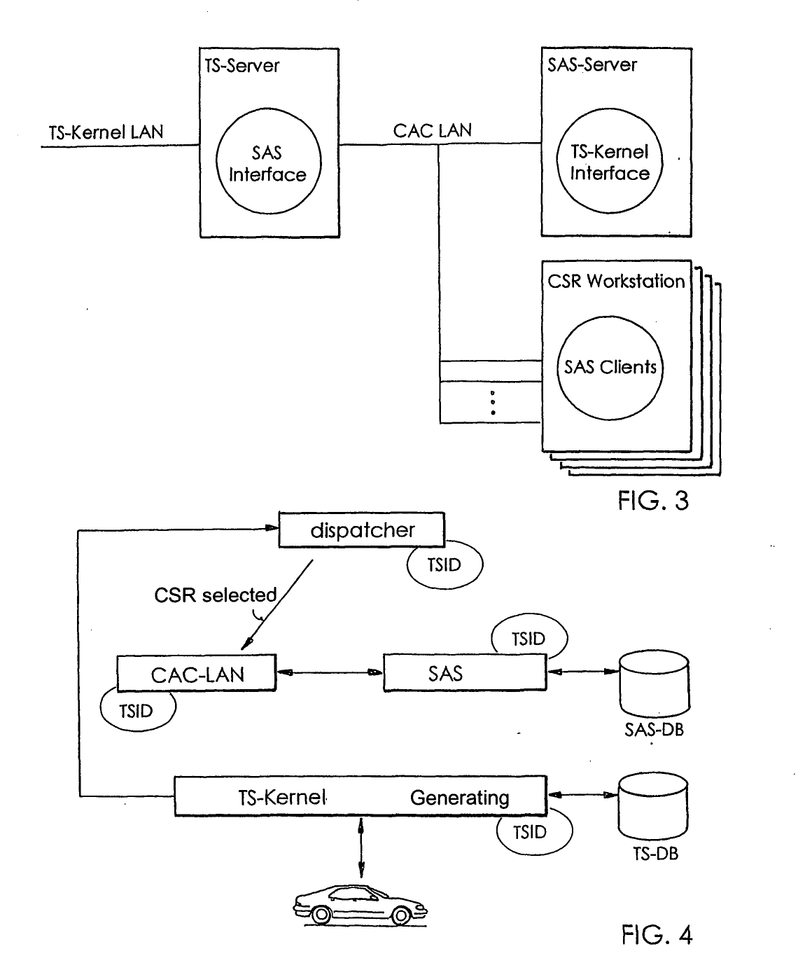

FIG. 3 shows a possible server structure for the telediagnosis system in the customer assistance center;

FIG. 4 shows how the application modules are tied into the central diagnostic program;

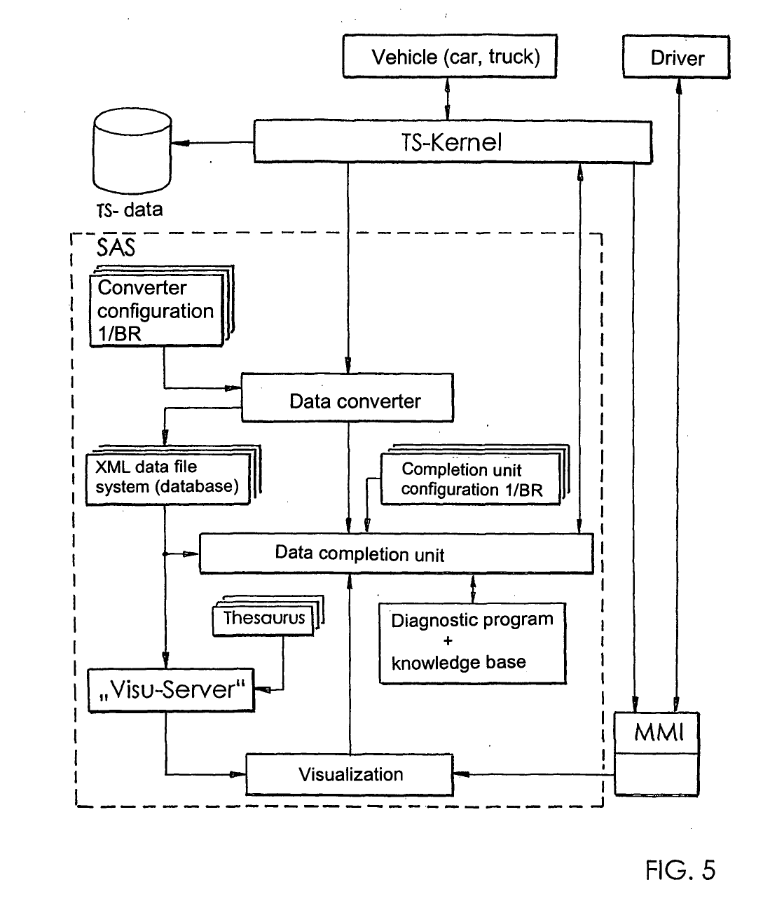

FIG. 5 shows a block diagram of a service assistant [sic; assistance] server;

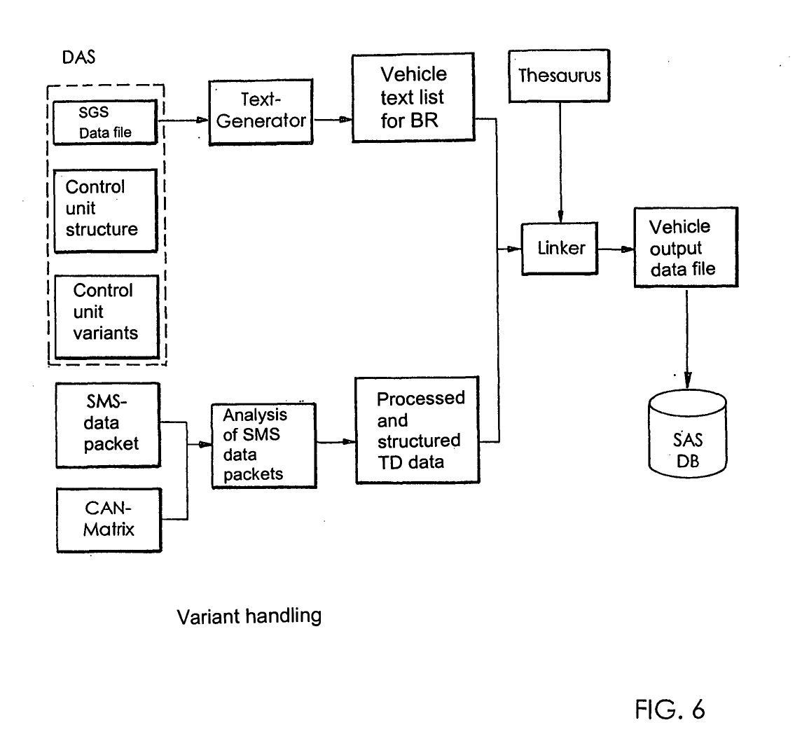

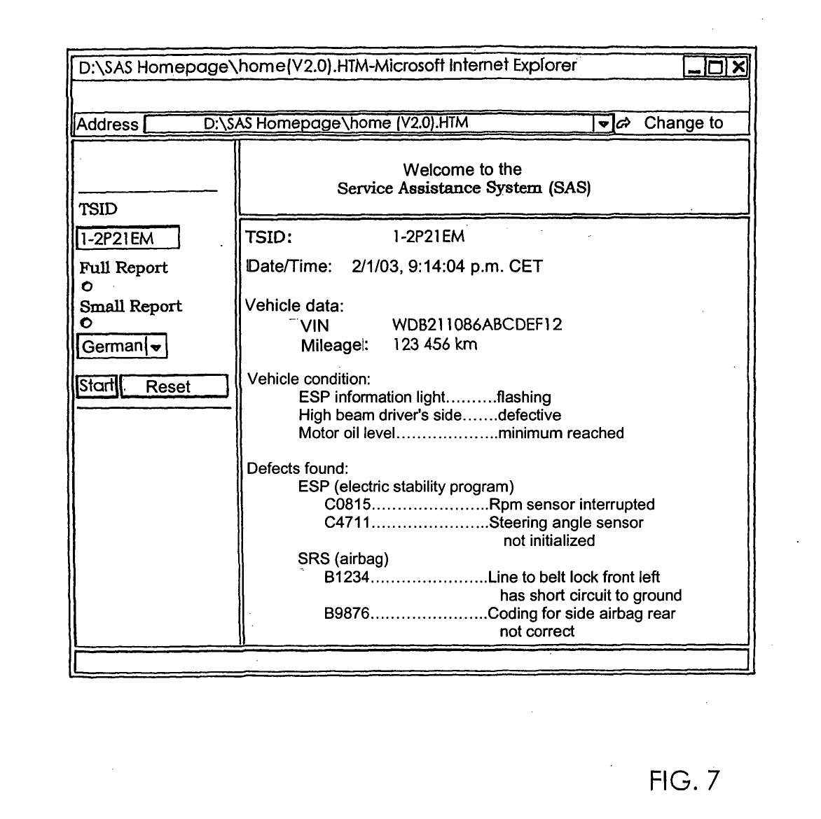

FIG. 6 shows an illustration of variant handling for various models;

FIG. 7 shows a screen excerpt of the telediagnosis viewer in the customer assistance center;

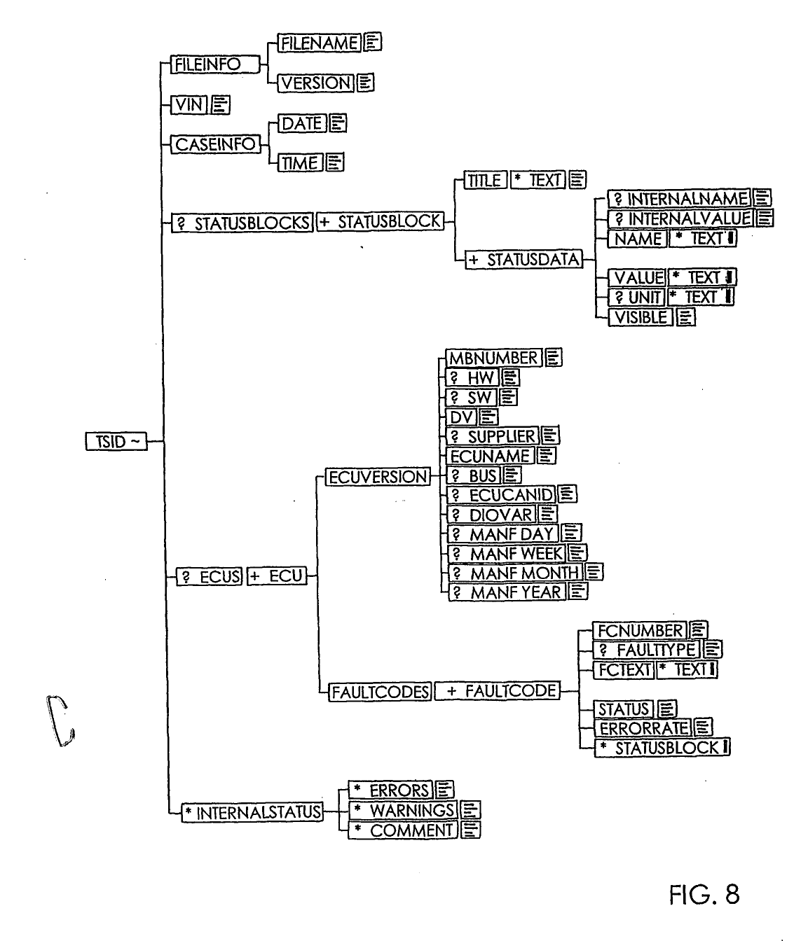

FIG. 8 shows a so-called data type definition for the XML output data file. The graphic display on the telediagnosis viewer is controlled with this XML output data file.

The basic structure of the inventive telediagnosis system is described below with reference to FIG. 1. For the handling of a vehicle breakdown in a call enter, a so-called customer assistance center, abbreviated CAC, a telediagnosis system in the form a data processing system is proposed. Such a system can process and display telediagnosis data from various model series. At the customer assistance center, a diagnostic program has been implemented on a central data processing platform. The diagnostic program has a link to a central database TSDB which contains information relevant to the diagnosis, e.g., about the structure of the vehicles to be diagnosed, empirical information from the past and identifiers for identifying the vehicles and the control units in the vehicle itself. The diagnostic program has a communications interface with the servers in the customer assistant center. The telediagnosis data is entered into the diagnostic system at the input end via a radio-based communications interface 1. The radio-based communications interface is based on the known standards for the mobile wireless telephone industry, in particular the formats of data transmission known as GSM and SMS (SMS for short message service) . To be able to receive calls of incoming mobile wireless messages from various vehicles, the telediagnosis system has a central communications platform TS kernel and a customer database TSDB. The communications platform performs an authorization inquiry with the help of the customer database for the incoming calls from the vehicles. This essentially checks on whether the inquiring vehicle is registered in the customer database TSDB. The vehicle identification number (VIN) is used to identify the vehicle.

Another object of the central communications platform is to determine the current position of the vehicle with the help of GPS data transmitted via mobile wireless. Therefore, digital roadmaps and street maps are additionally stored in the customer database TSDB; with the help of these maps, the communications platform TS kernel determines the position of the vehicle and, if necessary, the nearest service station where the vehicle can be repaired.

The extent of the available diagnostic data, which can be transmitted from the on-board system in the vehicle to the telediagnosis system in the customer assistance center includes here in particular the following data:
Status information about status values of the vehicle, e.g., battery voltage, firing position, position data, kilometer reading [mileage], tank filling and vehicle identification number (VIN). This data is transmitted as the initial data packet in a so-called initial TD message.
Additional information blocks which are transmitted only on request pertain to basic data, power management data, status data, maintenance computer data, vehicle configuration data, status of services, status information on the system diagnosis, components suspected of being defective, identification blocks of the control units, defective control units, control unit error codes, functions affected.

In contrast with previously known telediagnosis systems, basic data from the vehicle is first transmitted to the telediagnosis system in the customer assistance center with the initial data packet “initial TD message.” In another step, the additional information blocks listed above can be read out from the vehicle's on-board system on request and as needed and transmitted from the vehicle to the telediagnosis system.

When using the telediagnosis system with trucks and commercial vehicles, direct communication between the vehicle and the customer assistance center is not preferred, but instead data is exchanged via a centrally installed fleet board server which is preferably used by the shipping and logistics companies. The status and identification of the vehicle, the position data, the telephone number and the language of the driver, the date and time of day as well as information about the condition of the vehicle, including the control unit error codes, is transmitted here. Through the fleet board server, access to current maintenance data on the vehicle is also possible.

The communications platform TS kernel has two additional interfaces with the communications link in the customer assistance center. The TS kernel is connected to a so-called service assistant server SAS server in the computer network of the call center via a server interface SAS interface. The TS kernel is connected to the computer network for the workstations having display screens at the call center in the customer assistance center local area network CAC-LAN via a possible second interface CSR interface. The employees at the call center, the so-called customer service representatives CSR, have the option of influencing the communications process in the TS kernel via the workstations having display screens in the customer assistance center local area network. In particular, the customer service representatives can subsequently request specific data via the CSR interface.

With the service assistant server SAS server, the data thus transmitted is processed and displayed for the employees at the call center via a man-machine interface MMI in the form of a telediagnosis viewer. The service assistant server at the call center includes the following modules for data processing:
A data converter that converts the various data protocols that may be used in various on-board networks in passenger vehicles and trucks into a uniform data format, in particular an XML structure, by means of a converter configuration.
A data completion unit which reads model-specific subsequent data requests out of the vehicle to be diagnosed to the SAS interface via the diagnostic program by request by means of a completion unit configuration. The completed data is then displayed on the telediagnosis viewer MMI.

The data processing supported systems for the service assistant server for the actual diagnostic program and for the workstation computers in the local area network of the call center are based on the Windows NT4 operating system. The TCP/IP protocol standard is used as the data link between the systems. A Unix/Linux-based system would be a suitable alternative. The efficiency of the telediagnosis system takes into account the real-time requirements of the diagnostic process to permit contact between an employee at the call center and a service technician in the service station in real time. This also includes the ability to diagnose multiple vehicles at the same time.

FIG. 2 gives a process overview of the processes taking place on the service assistant server SAS server. The central element for communication among the various processes here is an error case identifier TSID, which is assigned by the central communications platform TS kernel to an incoming call from a vehicle. The various subprocesses are synchronized by means of the error case identifier, and the results of the various subprocesses are unambiguously assigned to a pending current diagnostic process. First the initial data packet arriving from the vehicle is subjected to an authorization check in the TS kernel. After a positive authorization check, the interface to the SAS server is initialized and the first initial data packet is analyzed in the SAS server and an automatic data completion is performed on the basis of a logic unit.

This initial processed diagnostic result is processed in text form with a thesaurus and is displayed on a telediagnosis viewer. The telediagnosis viewer serves to visualize the diagnostic results and also to provide further control, if another diagnostic sequence is necessary. The automatic data completion is performed by a completion unit configuration, which is essentially a conversion table specifying which model-specific data is additionally to be included in the diagnostic process, taking into account the current vehicle status. The model-specific data is symbolized with the data thus supplied. On the basis of the diagnostic result thus visualized and the error case identifier TSID, employees at the call center (CSR for customer service representative) can obtain additional information and thus can control the remaining sequence of the diagnostic process in a targeted manner. In the entire diagnostic process, the incoming call is assigned for processing together with the error case identifier TSID by an automatic dispatcher to an employee (CSR for customer service representative) at the call center. By means of the error case identifier TSID, the assignment of incoming calls to employees at the call center can be made in a specific manner according to each employee's qualifications. For example, an error in the engine controller may be sent specifically to a specialist in engine controllers an error in the antilock brake system could be forwarded specifically to a specialist in antilock brake systems.

FIG. 3 illustrates the minimum requirements of the network structure in the call center. Multiple data processing platforms in the form of CRS workstations are connected as SAS clients to the SAS server and to the TS server via a customer assistance center local area network CAC-LAN. The SAS server is the above-mentioned service assistant server, while the TS server is the data processing platform for the diagnostic program. The TS server and the SAS server communicate over the SAS interface and/or over the TS kernel interface and with SAS clients. Linking the SAS clients over a local area network offers the possibility of accessing the results of the telediagnosis compiled by the TS server and the SAS server from various workstation computers and displaying the results on the workstation computers via a telediagnosis viewer.

FIG. 4 illustrates again how the service assistance server SAS is tied into the telediagnosis system. The telediagnosis process is initiated at the vehicle end either by the driver of the vehicle or by automatic triggering by the vehicle's on-board diagnostic system. Triggering of the telediagnostic process by the driver is done by operating a special button in the vehicle, which can trigger the telediagnostic process. In automatic triggering of the telediagnostic process by the vehicle's on-board diagnostic system, the telediagnostic process is triggered by the occurrence and detection of an error or defect in the vehicle itself. By initiation of the telediagnostic process, the on-board data in the control units of the vehicle and/or in the error memory in the on-board diagnostic system is updated and a data link to the TS kernel is established. An initial data packet comprised of a vehicle identification number VIN, a digital time stamp and a digital error code is sent over the communications interface to the TS kernel. The TS kernel checks the access authorization to the telediagnosis system on the basis of the raw data from the vehicle and the entries in the customer database TSDB and saves the initial data packet in the form of a data object. This data object is assigned an error case identifier TSID. The incoming call from the vehicle triggers a trigger mechanism for the telediagnosis system in the TS kernel. After the call has been received, the interfaces from the TS kernel to the customer assistance center local area network CAC-LAN and to the service assistance server SAS are initialized and activated. In addition, each call received is assigned by a dispatcher to an employee CSR at the call center. The data flow is controlled here based on the error case identifier TSID. With reference to FIG. 5, the function of data completion is described below. An incoming call from the vehicle triggers a trigger mechanism for the service assistant center SAS in the central communications platform TS kernel. At the same time, the initial data packet from the vehicle's on-board diagnostic system is transferred from the TS kernel to the service assistance server SAS. This data and all additional telediagnostic data to be exchanged is converted into a data structure common to all models of the vehicle in a process that is controlled by the configuration of the data converter. Then the converted data is interpreted by a logic unit implemented in the software in the data completion unit program module. On the basis of the error states thus transmitted, the data blocks capable of supplying additional information on error states are determined on the basis of the error states thus transmitted. This information includes, for example, service data, operating values, status of the on-board system diagnosis in the vehicle, etc. The data packets thus obtained can be retrieved from the vehicle; they supply additional information about the error states and are transmitted automatically by the data completion unit to the TS kernel on request and are requested by the TS kernel and read out of the vehicle over the communications interface. For example, the status of the on-board system diagnosis in the vehicle is requested, received, converted and interpreted. For each defective control unit in the vehicle, the diagnostic data on the respective control unit is requested and transmitted per request. The incoming data is in turn converted by the data converter module into an XML structure and then stored. In the converted form of the telediagnostic data, the bits and bytes of the raw data are replaced by the respective thesaurus indices, representing a description of the information in text form. To display the data and the diagnostic results on the telediagnosis viewer, the thesaurus text messages are displayed by using the thesaurus indices that have already been assigned to the error codes. The thesaurus text messages are error text messages that are generally comprehensible and contain specifically the names of the components diagnosed. The employee at the call center can select the language in which the text messages are to be displayed by selecting a suitable thesaurus. The employee at the call center can thus have the diagnostic results displayed in English, for example, as the standard, or may select his native language for displaying the diagnostic results.

The function of the data converter is to generate a vehicle-independent XML data structure from raw data. The conversion procedure for each model series of a vehicle is obtained from a model-specific converter configuration. The data filename for the converted diagnostic result is generated automatically and is comprised of the error case identifier TSID plus a digital time stamp. Eight ten [sic; eighteen?] places in the data filename are reserved for the error case identifier TSID. The error case identifier is followed by the time stamp, then the year, month, day and hour, minute and second.

The data completion unit processes further the XML data structure generated by the data converter. To this end, the data completion unit has a logic unit, which is set up by the completion unit configuration for each model series. The telediagnostic data in the XML data structure is analyzed with this logic unit. Any subsequent requests for data from the vehicle that become necessary are then determined on the basis of the available data and the configuration. Depending on the choice of whether all data is to be retrieved and/or displayed or only data relevant to errors, the subsequent requests to the vehicle for data are formulated after analysis of the first initial data packet transmitted. The initial data packet contains basic vehicle data, e.g., the vehicle identification number VIN, a time stamp, vehicle position data, voltage values of control units, the firing position of the ignition lock and status messages of selected devices and the status of warning lamps on the dashboard of the vehicle. In addition, a list is transmitted with the initial data packet, marking the control units that have been identified as defective by the on-board diagnosis. The data completion unit analyzes the data from the initial data packet, converted by the data converter into an XML data file. The control units marked as defective in the initial data packet lead to a subsequent data request after analysis by the data completion unit. In the subsequent data request, additional data, e.g., the status block of the control unit, can be read out of the control unit marked as defective. If the diagnostic program on which the telediagnosis system is based is a model-based diagnostic program, then other ambient data will also be read out of the vehicle, so that other ambient data that can describe the error in greater detail is read out of the vehicle. This ambient data includes, for example, the status data of the neighboring control units in the hierarchy, nearest to the control unit diagnosed as defective. All vehicle data may also be requested as an alternative. The subsequent data request is also transmitted over the radio-based communications interface, i.e., via mobile wireless, preferably using the SMS standard.

The analyzer logic unit for the subsequent data request is designed here to be configurable. This allows adaptation of the data packets transmitted to model-specific particulars of each vehicle. The configuration is recorded in an XML data file, labeled as a completion unit configuration in FIG. 5. The information on the completion unit configuration is re-input with each new call, thereby determining with which additional subsequent request for data the telediagnosis system will respond to the initial data packet received previously. The completion unit configuration is model-specific and can be adapted accordingly when there are changes in the model series of the vehicles. If the diagnostic program with the subsequently requested data does not arrive at a satisfactory diagnostic result, then in addition to the automatically triggered subsequent request for data already described, there is the additional option of a subsequent request for data by the employee at the call center. To do so, the previous diagnostic result is displayed on the telediagnosis viewer. The employee at the call center can then evaluate the previous diagnostic result. For additional subsequent requests for data that are made manually, the employee at the diagnostic center can specifically request additional status data on the vehicle via the diagnostic program and have this data read out. The employee at the call center also has the option of asking the driver of the vehicle by telephone about the error symptoms that have occurred in the vehicle.

With reference to FIG. 6, details of the visualization of the diagnostic result on the telediagnosis viewer are discussed again below. For the visualization of the telediagnosis results, the data must first be linked to the corresponding thesaurus text messages via a process of “incorporating the thesaurus.” A linker is responsible for incorporating the thesaurus. On-board the vehicle, a table is provided for the error codes for the installed control units as the SGS data file, a data file containing information on the control unit structure and a data file containing information on the installed control unit variants. There are usually variations in the installed control unit variants from one model series to the next. Identification of the specific control units installed in each case is made by the on-board diagnostic system, e.g., by the network addresses of the control units. These network addresses are preferably so-called CAN identifiers. By means of a text generator, a model-specific and vehicle-specific text list is generated in the form of a data file containing the thesaurus indices relevant for this vehicle; this text list is generated from the information about the control unit structure obtained from the stock database (SGS data file) along with the information on the control unit variants and the possible error, codes for the installed control units. By means of these thesaurus indices, the linker can subsequently connect the relevant assigned thesaurus text messages in the various languages that can be selected for display in the telediagnosis system. The choice of which text messages are ultimately to be output depends on the particular diagnostic data in each case. In this regard, the SMS data packets incoming from the vehicle are analyzed and, as explained in conjunction with FIG. 5, a processed and structured diagnostic result in the form of telediagnostic data is generated. By means of the error codes of the diagnostic result and the thesaurus indices referencing these error codes, the error text relevant for this diagnostic result is selected and linked to the diagnostic result. The diagnostic result generated and structured in this way is either displayed or stored temporarily as a vehicle output data file in a memory medium belonging to the service assistant server.

Finally, FIG. 7 shows a visualization of the diagnostic result generated with the telediagnosis system and telediagnosis method described above. This shows the error case identifier TSID, the digital time stamp and the basic vehicle information, such as the vehicle identification number VIN and the vehicle's kilometer reading [mileage]. The vehicle status provides information about the errors that have occurred. In the exemplary embodiment shown here, it was found that the high beam light on the driver's side was defective and the motor oil level had reached the minimum. Furthermore, a defect was found in the electronic stability program ESP; this was displayed on the dashboard by a flashing ESP information light. The telediagnosis system found two possible error causes for the flashing ESP information light. The error causes were displayed with the error code and the thesaurus text assigned to this error code. The defects in the high-beam light and the improperly functioning electronic stability program can be perceived as defects by the driver of the vehicle, but the defects involving the safety system airbag that were also found by the diagnostic system are not readily apparent to the driver. Two defects were found in the airbags. First, the line to the seatbelt lock at the left front had a short circuit, and secondly, at least one airbag in the rear of the vehicle had an incorrect code, i.e., the network address of the control unit would have to be checked.

Within the local area network of the call center, preferably implemented as an intranet, the vehicle data compiled and processed by the data converter can be observed on a telediagnosis viewer as a browser. The selection of the data record displayed in the browser is made here by entering the proper error case identifier TSID. The standard settings in the browser with regard to the language that can be selected and the extent of the report can be set by a network administrator at the call center via an INI data file. The data record to be displayed itself is supplied by the Visu Server shown in FIG. 5. This Visu Server accesses the vehicle data and processes it to a suitable display, e.g., with the help of the DTD data file, shown as an example in FIG. 8, for XML applications. For the user there is the option of selecting between a minimum extent (“short report” for selecting the most important vehicle data) and the maximum extent (“full report” for all data available from the vehicle) . The desired language can be set by a selection. All languages represented in the thesaurus and/or with the thesauruses and contained in the system are possible. In addition, a simple message regarding the processing status of the diagnostic result or the status of processing of the error message can be displayed in the browser. An automatic update of the window contents in the telediagnosis viewer is performed until all desired data that might be supplied subsequently by the data completion unit is available. The vehicle data thus displayed may be printed out in a readable format or sent as email. This is especially helpful in advising a service station from the call center. Then the screen printout can be sent directly as a vehicle breakdown fax to the service station. In addition to the language test messages, the error codes (fault codes) are also retained and displayed (see also FIG. 7). By retaining the error codes, it is always possible to access the raw data from the vehicle just as it is in the control unit of the vehicle being diagnosed. With the help of the error codes, it is also possible to trace back the information flow, i.e., the program sequence of the diagnostic program, for debugging purposes. The debugging function is especially helpful when the diagnostic program does not arrive at an unambiguous result or when a diagnosis fails completely.

1. Man-machine interface (MMI) for a diagnostic system for diagnosing a technical system with a knowledge base and a diagnostic program that supplies a preliminary diagnostic result in the form of an initial data packet comprising:
a data converter, which converts the initial data packet into an XML structure and saves it as an XML data file on the basis of a converter configuration,
a data completion unit that analyzes the data of the XML data file and reads out additional data by request from the technical system to be diagnosed after setting a manual request and saves it in the XML data file after conversion by means of a completion unit configuration,
and a visualization of the XML elements saved in the XML data file in the form of an inactive user surface.

2. Man-machine interface (MMI) as claimed in claim 1, wherein at least one thesaurus is included and the XML elements are linked to the particular current thesaurus by indices and the text messages from the thesaurus are displayed.

3. Man-machine interface as claimed in claim 1, wherein the visualization is performed by using an Internet browser.

4. Man-machine interface as claimed in claim 1, wherein the initial data packet is comprised of at least one digital vehicle identification number (VIN), an error case identifier (TSID) and a digital time stamp.

5. Man-machine interface as claimed in claim 1, wherein the completion unit configuration contains a logic unit configured for the model series of the particular technical system to be diagnosed, by means of which the required additional model-specific data is determined dynamically on the basis of the data already available and is read out of the technical system on request and stored after being converted into the XML data file.

6. Man-machine interface as claimed in claim 1, wherein the progress display for the status of the data communication with the technical system to be diagnosed is also included.

7. Man-machine interface as claimed in claim 1, wherein several thesauruses in different languages can be used to display the data contents of the XML elements in text form according to the selection made by the user in a selectable language.

8. Man-machine interface as claimed in claim 2, wherein the visualization is performed by using an Internet browser.

9. Man-machine interface as claimed in claim 2, wherein the initial data packet is comprised of at least one digital vehicle identification number (VIN), an error case identifier (TSID) and a digital time stamp.

10. Man-machine interface as claimed in claim 3, wherein the initial data packet is comprised of at least one digital vehicle identification number (VIN), an error case identifier (TSID) and a digital time stamp.

11. Man-machine interface as claimed in claim 2, wherein the completion unit configuration contains a logic unit configured for the model series of the particular technical system to be diagnosed, by means of which the required additional model-specific data is determined dynamically on the basis of the data already available and is read out of the technical system on request and stored after being converted into the XML data file.

12. Man-machine interface as claimed in claim 3, wherein the completion unit configuration contains a logic unit configured for the model series of the particular technical system to be diagnosed, by means of which the required additional model-specific data is determined dynamically on the basis of the data already available and is read out of the technical system on request and stored after being converted into the XML data file.

13. Man-machine interface as claimed in claim 4, wherein the completion unit configuration contains a logic unit configured for the model series of the particular technical system to be diagnosed, by means of which the required additional model-specific data is determined dynamically on the basis of the data already available and is read out of the technical system on request and stored after being converted into the XML data file.

14. Man-machine interface as claimed in claim 2, wherein the progress display for the status of the data communication with the technical system to be diagnosed is also included.

15. Man-machine interface as claimed in claim 3, wherein the progress display for the status of the data communication with the technical system to be diagnosed is also included.

16. Man-machine interface as claimed in claim 4, wherein the progress display for the status of the data communication with the technical system to be diagnosed is also included.

17. Man-machine interface as claimed in claim 5, wherein the progress display for the status of the data communication with the technical system to be diagnosed is also included.

18. Man-machine interface as claimed in claim 2, wherein several thesauruses in different languages can be used to display the data contents of the XML elements in text form according to the selection made by the user in a selectable language.

19. Man-machine interface as claimed in claim 3, wherein several thesauruses in different languages can be used to display the data contents of the XML elements in text form according to the selection made by the user in a selectable language.

20. Man-machine interface as claimed in claim 4, wherein several thesauruses in different languages can be used to display the data contents of the XML elements in text form according to the selection made by the user in a selectable language.
